(19) United States
(12) Patent Application Publication
(10) Pub. No.: US 2018/0145784 A1
(43) Pub. Date: May 24, 2018

(54) DEVICE AND METHOD FOR TRANSMITTING AND RECEIVING EMERGENCY SIGNALS USING A WIRELESS COMMUNICATION NETWORK

(71) Applicant: HUAWEI TECHNOLOGIES CO., LTD., Shenzhen (CN)

(72) Inventors: Chan ZHOU, Munich (DE); Ömer Bulakci, Munich (DE); Josef Eichinger, Munich (DE)

(21) Appl. No.: 15/860,660

(22) Filed: Jan. 3, 2018

Related U.S. Application Data
(63) Continuation of application No. PCT/EP2015/065221, filed on Jul. 3, 2015.

(51) Int. Cl. H04J 13/00; H04W 74/08

(52) U.S. Cl. CPC H04J 13/004; H04W 74/0833

(57) ABSTRACT

A communication device for use in a communication system is provided. The communication device comprises a priority message generator configured to obtain a piece of priority information, and to generate a priority message based on the piece of priority information and a priority information encoding rule. The priority message comprises a combination of at least two sequences of a plurality of orthogonal sequences. The combination of the at least two sequences of the plurality of sequences indicates the obtained priority information. Moreover, the communication device comprises a transmitter configured to transmit the priority message. Moreover, an according receiving communication device, an according transmitting method and an according receiving method are provided.

### CROSS-REFERENCE TO RELATED APPLICATIONS

This application is a continuation of International Patent Application No. PCT/EP2015/065221, filed on Jul. 3, 2015, which is hereby incorporated by reference in its entirety.

### TECHNICAL FIELD

The invention relates to transmitting priority messages in communication systems, especially cellular communication systems.

### BACKGROUND

In future, a number of new services will be enabled by mobile and wireless communication systems. In contrast to conventional wireless services, the new services have additional demands on system capability, such as a higher reliability, a higher robustness and a significantly lower latency. For instance, wireless solutions can be applied to teleprotection systems for the exchange of messages and commands. Compared to conventional wired solutions, a wirelessly connected teleprotection system has a higher flexibility and reduced deployment costs.

However, teleprotection systems have particular requirements regarding reaction latency: Once a failure occurs, the effected part should be selectively disconnected from the electric network within the shortest possible time. The generally agreed upon target duration of the delay spent for the communication should be less than 10 ms. This requirement is far beyond the capability of current cellular networks.

The long-term evolution (LTE) network, for example, needs up to around 100 ms for a one-way transmission. Further services, such as traffic safety and industrial autonomous control, pose similar delay challenges, when integrated into the cellular network.

Considering the whole transmission procedure in mobile and wireless communication systems, it can be observed that the so far employed random access procedure is a major contributor to the transmission latency. The random access procedure is necessary if traffic requests are unpredictable and cannot be scheduled in advance, which is the case for the above-mentioned mission-critical services. A random access procedure in an LTE network needs 4050 ms. This duration is even extended if collisions occur, i.e., more than one device tries to use the same random access resource at the same time. The collision resolution and retransmission of the random request will introduce additional delay into the random access procedure. In some cases, in particular when a number of devices try to access the network at the same time, the latency caused by random access could easily exceed 100 ms.

In view of these facts, a new scheme is necessary, which is able to reduce the delay in the transmission procedure and, thus, enable the mission-critical services with strict latency requirements.

### SUMMARY

Accordingly, an object of the present invention is to provide a communication device for transmitting priority information, a communication device for receiving priority messages, and according methods, which allow for very low latency times.

The object is solved by the features of claim 1 for the communication device for transmitting priority messages, claim 7 for the communication device for receiving priority messages, by claim 13 for the method for transmitting priority messages, and claim 14 for the method for receiving priority messages. Further it is solved by the features of claim 15 for the associated computer program. The dependent claims contain further developments.

According to a first aspect, a communication device for use in a communication system is provided. The communication device comprises a priority message generator configured to obtain a piece of priority information, and to generate a priority message based on the piece of priority information and a priority information encoding rule. The priority message comprises a combination of at least two sequences of a plurality of orthogonal sequences. The combination of the at least two sequences of the plurality of sequences indicates the obtained priority information. Moreover, the communication device comprises a transmitter configured to transmit the priority message. It is thereby possible to transmit priority messages without having to request transmission resources resulting in a very low transmission delay.

In a first implementation form of the communication device according to the first aspect the combination of the at least two sequences is defined by the at least two sequences and their time and/or frequency relationship to each other. Especially, the combination can be defined by the selection of the at least two sequences as such and/or their time and/or frequency relationship. A great flexibility in selecting the combination can thereby be achieved.

In a second implementation form of the communication device according to the first aspect as such or according to the first implementation form of the first aspect the priority information encoding rule defines which individual sequences of the plurality of orthogonal sequences are selected as the at least two sequences for generating the priority message and which time and/or frequency relationship the at least two selected sequences have in the generated priority message. It is thereby easily possible to encode useful information in the combination of sequences.

In a third implementation form of the communication device according to the first aspect as such or according to any of the preceding implementation forms of the first aspect, the priority information encoding rule may be a look-up table mapping each piece of priority information to a combination of at least two sequences, wherein the priority information encoding rule is configured such that different pieces of priority information are mapped to different combinations of the at least two sequences. Alternatively, a mathematic function taking the priority information as input and returning the combination of at least two sequences can be employed. A great encoding flexibility thereby can be reached.

In a fourth implementation form of the communication device according to the first aspect as such or according to any of the preceding implementation forms of the first aspect, the communication system may be configured to use individual sequences of the plurality of sequences for a contention or non-contention based random access procedure. This is for example implemented into the current LTE standard. A very efficient spectrum usage can thereby be achieved.

In a fifth implementation form of the communication device according to the first aspect as such or according to any of the preceding implementation forms of the first aspect, the at least two sequences are at least two different sequences of the plurality of orthogonal sequences, and/or have a time and/or frequency shift regarding each other, and/or are overlapped in time and/or frequency regarding each other. A further increase in encoding flexibility can thereby be reached.

In a sixth implementation form of the communication device according to the first aspect as such or according to any of the preceding implementation forms of the first aspect, the plurality of sequences are a plurality of Zadoff-Chu sequences, Pseudo Noise (PN) sequences, Gold Code sequences, Kasami Code sequences, Walsh-Hadamard code sequences or Barker Code sequences. By using these well-known types of orthogonal sequences, the individual sequences but also the combinations of sequences can be reliably detected and distinguished from each other.

In a seventh implementation form of the communication device according to the first aspect as such or according to any of the preceding implementation forms of the first aspect, the communications system is configured to use individual sequences of the plurality of orthogonal sequences for a random access procedure to establish a radio communication channel. It is thereby possible to very efficiently use the available frequency resources. Also for implementation reasons, this is beneficial, since for receiving the sequences the number and size of different matched filters can thereby be reduced.

In an eighth implementation form of the communication device according to the first aspect as such or according to any of the preceding implementation forms of the first aspect, the communication device further comprises a conventional message generator configured to generate a conventional message comprising one individual sequence of the plurality of orthogonal sequences for initiating a contention or none-contention based random access procedure to establish a dedicated radio communication channel, e.g. for user data, e.g. dedicated traffic channel, DTCH, for LTE. It is thereby possible to transmit priority messages and conventional messages by the same communication device. A very flexible use is thereby possible. Especially, for conventional messages, it is possible to request resources and thereby avoid message collisions, while at the same time it is possible to directly transmit priority messages.

In a ninth implementation form according to the eighth implementation form of the communication device according to the first aspect as such, the conventional message generator is configured to generate random access preambles using advantageously only one of the sequences of the plurality of orthogonal sequences for establishing the radio communication channel. This helps keeping the receiver complexity low, since only a limited number of matched filters is required.

In a tenth implementation form of the communication device according to the first aspect as such or according to any of the preceding implementation forms of the first aspect, the communication device is a long term evolution communication (LTE) device. In this case, the plurality of orthogonal sequences are Zadoff-Chu sequences of a same set as used for random access preambles according to LTE. Moreover, in this case the random access preambles and the priority messages are sent in the common RACH channel. A very simple implementation of the invention into LTE is thereby possible.

In an eleventh implementation form of the communication device according to the first aspect as such or according to the any of the first to eighth implementation forms of the first aspect, the invention can also be implemented into UMTS or any other compatible communication standard.

In a twelfth implementation form of the communication device according to the first aspect as such or according to any of the preceding implementation forms of the first aspect, the communication device further comprises a receiver configured to receive the priority information encoding rule or at least a part of the priority information encoding rule and a memory storage configured to store the priority information encoding rule or the at least a part of the priority information rule. The priority message generator is then configured to obtain the priority information encoding rule from the memory. It is thereby possible to update the priority information encoding rule within the communication device. Such an update might also be useful to prevent message spoofing or to extend the functionality.

In a thirteenth implementation form of the communication device according to the twelfth implementation form of the first aspect the received complete or partial priority information encoding rule may include the individual sequences as such and the corresponding order to be used for generating the priority message, for other information presenting and or indicating the individual sequences, for example indices or any other information allowing to construct the combinations of the individual sequences from a seed. Moreover, the received complete or partial priority information encoding rule may include the time and/or frequency relationships, e.g. by offsets of the individual sequences with regard to each other or offsets with regard to some reference time, for example time slot beginning, sub-frame beginning; offsets can also be zero.

Alternatively, reference sequences and/or an absolute time and/or frequency information regarding for example a specific sub-band, etc. may be comprised. Moreover, the received complete or partial priority information encoding rule may include the mapping of the priority information to the individual sequence combinations, for example sequences as such and their specific time and/or frequency relationship. In certain embodiments, only sequences are updated or received, wherein the number and the time and/or frequency relationships remain. Also an update only of the number and the time and/or frequency relationships without updating the sequences as such is possible. Also a partial update of only a part of the sequences and/or a part of the time and/or frequency relationships is possible.

In a fourteenth implementation form of the communication device according to the first aspect as such or according to any of the preceding implementation forms of the first aspect the priority information is an alarm, especially a fire alarm or a defect notification or an emergency message. A very wide priority of priority information can thereby be handled by the inventive communication device.

In a fifteenth implementation form of the communication device according to the first aspect as such or according to any of the preceding implementation forms of the first aspect each of the sequences of the plurality of the orthogonal sequences is orthogonal to all time and/or frequency shifted versions of itself, every other sequence of the plurality of sequences, and all time and/or frequency shifted versions of every other sequence of the plurality of sequences. A very high degree of separation of the individual sequences can thereby be achieved.

In a sixteenth implementation form of the communication device according to the fifteenth implementation form of the first aspect the sequences being orthogonal comprises the sequences having an autocorrelation peak at 0 lag above a first threshold, the sequences having a cross-correlation below a second threshold regarding all time and/or frequency shifted versions of itself, every other sequence of the plurality of sequences, and all time and/or frequency shifted versions of every other sequence of the plurality of sequences. An especially good separation of the individual sequences is thereby possible.

According to a second aspect, a communication device for use in a communication system is provided. The communication device comprises a receiver configured to receive sequences of a plurality of orthogonal sequences and a decoder configured to decode, based on a priority information decoding rule, a piece of priority information encoded in a priority message comprising a combination of at least two sequences of the plurality of orthogonal sequences. It is thereby possible to receive the priority message and decode the priority information carried by the priority message at low latency and with low hardware effort and efficient resource use.

In a first implementation form of the communication device according to the second aspect, the decoder is configured to detect whether the at least two received sequences from the plurality of orthogonal sequences for a priority message, by determining whether the at least two sequences as such and their time and/or frequency relationship match a known combination of at least two sequences forming a priority message. A very exact determination, if a received combination of at least two sequences is constituting a priority message, or not is thereby possible.

In a second implementation form of the communication device according to the second aspect as such or according to the first implementation form of the second aspect the combination of the at least two sequences is defined by the at least two sequences and their time and/or frequency relationship to each other. Especially, the combination can be defined by the selection of the at least two sequences as such and/or their time and/or frequency relationship. A great flexibility in selecting the combination can thereby be achieved.

In a third implementation form of the communication device according to the second aspect as such or according to any of the preceding implementation forms of the second aspect, the priority information decoding rule defines which individual sequences of the plurality of orthogonal sequences are selected as the at least two sequences for generating the priority message and which time and/or frequency relationship the at least two selected sequences have in the generated priority message. It is thereby easily possible to decode useful information in the combination of sequences.

In a fourth implementation form of the communication device according to the second aspect as such or according to any of the preceding implementation forms of the second aspect, the priority information decoding rule may be a look-up table mapping each piece of priority information to a combination of at least two sequences, wherein the priority information encoding rule is configured such that different pieces of priority information are mapped to different combinations of the at least two sequences. Alternatively, a mathematic function taking the priority information as input and returning the combination of at least two sequences can be employed. A grade encoding flexibility thereby can be reached.

In a fifth implementation form of the communication device according to the second aspect as such or according to any of the preceding implementation forms of the second aspect, the communication system may be configured to use individual sequences of the plurality of sequences for a contention or non-contention based random access procedure. This is for example implemented into the current LTE standard. A very efficient spectrum usage can thereby be achieved.

In a sixth implementation form of the communication device according to the second aspect as such or according to any of the preceding implementation forms of the second aspect, the decoder is configured to detect, based on the priority information decoding rule, whether a combination of at least two received sequences of the plurality of orthogonal sequences and their time and/or frequency relationship match a combination of at least two sequences comprised in a priority message.

In a seventh implementation form of the communication device according to the second aspect as such or according to any of the preceding implementation forms of the second aspect the decoder is configured to decode based on the priority information decoding rule, the piece of priority information, by determining to which combination of at least two sequences comprised in a priority message, the received at least two sequences as such and their time and/or frequency relationship match to. A very accurate and efficient decoding is thereby possible.

Advantageously, a matching of combinations of at least two sequences of the plurality of sequences to valid combinations of sequences forming priority messages is performed. An especially accurate one-step matching and decoding can thereby be performed. Alternatively, the matching and decoding are separate steps. In this case, first a matching of individual sequences within the received signal is performed. The detected matching sequences are then afterwards checked regarding valid sequence combinations forming priority messages. This allows for a lower number of required matched filters.

In an eighth implementation form of the communication device according to the second aspect as such or according to any of the preceding implementation forms of the second aspect, the priority information is an alarm, especially a fire alarm or a defect notification or an emergency message. A very wide priority of priority information can thereby be handled by the inventive communication device.

In a ninth implementation form of the communication device according to the second aspect as such or according to any of the preceding implementation forms of the second aspect each of the sequences of the plurality of the orthogonal sequences is orthogonal to all time and/or frequency shifted versions of itself, every other sequence of the plurality of sequences, and all time and/or frequency shifted versions of every other sequence of the plurality of sequences. A very high degree of separation of the individual sequences can thereby be achieved.

In a tenth implementation form of the communication device according to the ninth implementation form of the second aspect, the sequences being orthogonal comprises the sequences having an autocorrelation peak at 0 lag above a first threshold, the sequences having a cross-correlation below a second threshold regarding all time and/or frequency shifted versions of itself, every other sequence of the plurality of sequences, and all time and/or frequency shifted versions of every other sequence of the plurality of sequences. An especially good separation of the individual sequences is thereby possible.

In a eleventh implementation form of the communication device according to the second aspect as such or according to any of the preceding implementation forms of the second aspect, the decoder is configured to decode, based on the priority information decoding rule, the piece of priority information, by evaluating a channel state parameter of a transmission channel of the priority message. It is thereby possible to increase the accuracy of determining, if an actual priority message is present, or whether merely an accidental overlap of regular preambles sent by different devices has occurred.

Especially since a channel state can be estimated based on a power delay profile of each received individual sequence, the decoding communication device is able to detect whether two sequences have passed through the same channel and therefore come from the same transmitting communication devices. Furthermore, if the transmitting communication device is stationary and the channel state is static on a large time scale, the static channel state information, which is known at the receiving communication device (decoder) can be used to verify if the sequence is sent be a particular device.

In a twelfth implementation form of the communication device according to the second aspect as such or according to any of the preceding implementation forms of the second aspect, to facilitate this determination, the priority information decoding rule may additionally include a channel state parameter information.

In a thirteenth implementation form of the communication device according to the second aspect as such or according to any of the preceding implementation forms of the second aspect, the decoder is configured to decode the piece of priority information by matched filtering received sequences using individual reference sequences of the plurality of orthogonal sequences as a reference, and detecting a reference sequence of the plurality of the orthogonal sequences if a calculated power delay profile for the individual reference sequences is larger than a detection threshold. Moreover, in this case, the decoder is configured for detecting the priority message if a time and/or frequency relationship between peaks of detected individual reference sequences match the combination of at least two sequences of the priority message. Especially accurate and resource efficient detection is thereby possible.

In a fourteenth implementation form of the communication device according to the second aspect as such or according to any of the preceding implementation forms of the second aspect, a communication system is configured to use individual sequences of the plurality of sequences for a random access procedure to establish a radio communication channel. By using the individual sequences for either the priority messages or as preambles, an especially efficient resource use can be achieved.

In a fifteenth implementation form of the communication device according to the second aspect as such or according to any of the preceding implementation forms of the second aspect, a communication device further comprises a priority information encoding updater configured to update the priority information encoding rule and priority information decoding rule or at least a part of the priority information encoding rule and priority information decoding rule. Moreover, it comprises a memory for storing the priority information decoding rule or the at least part of the priority information decoding rule. Also, the decoder is configured to obtain the priority information decoding rule from the memory. The decoder furthermore comprises a transmitter configured to transmit the priority information encoding rule or the at least part of the priority information encoding rule. It is thereby possible to update the encoding and decoding rules, taking in account the changed device functionality or as a preventive measure for dealing with orthogonal messages.

In a third aspect, a method for communicating in a communication system is provided. The method comprises obtaining a piece of priority information and generating a priority message based on the piece of priority information and a priority information encoding rule, by a communications device. The priority message comprises a combination of at least two sequences of a plurality of orthogonal sequences. The combination of the at least two sequences of the plurality of sequences indicates the obtained priority information. Moreover, the method comprises transmitting the priority message. It is thereby possible to transmit a priority message comprising the obtained priority information with a very low delay and at the same time efficiently using available radio resources.

In a first implementation form of the method according to the third aspect, the combination of the at least two sequences is defined by the at least two sequences and their time and/or frequency relationship to each other. Especially, the combination can be defined by the selection of the at least two sequences as such and/or their time and/or frequency relationship. A great flexibility in selecting the combination can thereby be achieved.

In a second implementation form of the method according to the third aspect as such or according to the first implementation form of the third aspect, the priority information encoding rule defines which individual sequences of the plurality of orthogonal sequences are selected as the at least two sequences for generating the priority message and which time and/or frequency relationship the at least two selected sequences have in the generated priority message. It is thereby easily possible to encode useful information in the combination of sequences.

In a third implementation form of the method according to the third aspect as such or according to any of the preceding implementation forms of the third aspect, the priority information encoding rule may be a look-up table mapping each piece of priority information to a combination of at least two sequences, wherein the priority information encoding rule is configured such that different pieces of priority information are mapped to different combinations of the at least two sequences. Alternatively, a mathematical function taking the priority information as input and returning the combination of at least two sequences can be employed. A grade encoding flexibility thereby can be reached.

In a fourth implementation form of the method according to the third aspect as such or according to any of the preceding implementation forms of the third aspect, the at least two sequences are at least two different sequences of the plurality of orthogonal sequences, and/or have a time and/or frequency shift regarding each other, and/or overlapped in time and/or frequency regarding each other. A further increase in encoding flexibility can thereby be reached.

In a fifth implementation form of the method according to the third aspect as such or according to any of the preceding implementation forms of the third aspect, the plurality of sequences are a plurality of Zadoff-Chu sequences, Pseudo Noise (PN) sequences, Gold Code sequences, Kasami Code sequences, Walsh-Hadamard code sequences or Barker Code sequences. By using these well-known types of sequences, a simple implementation can be reached.

In a sixth implementation form of the method according to the third aspect as such or according to any of the preceding implementation forms of the third aspect, the communications system is configured to use individual sequences of the plurality of orthogonal sequences for a random access procedure to establish a radio communication channel. It is thereby possible to very efficiently use the available frequency resources. Also for implementation reasons, this is beneficial, since for receiving the sequences the number and size of different matched filters can thereby be reduced.

In a seventh implementation form of the method according to the third aspect as such or according to any of the preceding implementation forms of the third aspect, the method further comprises generating a conventional message, comprising, advantageously only comprising, individual sequences of the plurality of orthogonal sequences for initiating a contention or none-contention based random access procedure to establish a advantageously dedicated radio communication channel, e.g. for user data, e.g. dedicated traffic channel, DTCH, transmitting user data for LTE. It is thereby possible to transmit priority messages and conventional messages by the same communication device. A very flexible use is thereby possible. Especially, for conventional messages, it is possible to request resources and thereby avoid message collisions, while at the same time it is possible to directly transmit priority messages.

In an eighth implementation form of the method according to the third aspect as such or according to any of the preceding implementation forms of the third aspect, the method comprises generating random access preambles, using, advantageously only one of the sequences of the plurality of orthogonal sequences for establishing the radio communication channel. This helps keeping the receiver complexity low, since only a limited number of matched filters corresponding to the number of used individual sequences is required. Each additional matched filter increases system complexity.

In a ninth implementation form of the method according to the third aspect as such or according to any of the preceding implementation forms of the third aspect, the communication device is a long term evolution communication (LTE) device. In this case, the plurality of orthogonal sequences are Zadoff-Chu sequences of a same set used for random access preambles according to LTE. Moreover, in this case the random access preambles and the priority messages are send in the common RACH channel. A very simple implementation of the invention into LTE is thereby possible.

In a tenth implementation form of the method according to the third aspect as such or according to any of the first implementation form to the eighth implementation form of the third aspect the invention can also be implemented into UMTS or any other compatible communication standard.

In a eleventh implementation form of the method according to the third aspect as such or according to any of the preceding implementation forms of the third aspect, the method further comprises receiving the priority information encoding rule or at least a part of the priority information encoding rule and storing the priority information encoding rule or the at least a part of the priority information rule. The method then comprises obtaining the stored priority information encoding rule. It is thereby possible to update the priority information encoding rule within the communication device. Such an update might also be useful to prevent message spoofing or to extend the functionality.

Advantageously, the received complete or partial priority information encoding rule may include the individual sequences as such and the corresponding order to be used for generating the priority message, for other information presenting and/or indicating the individual sequences, for example indices or any other information allowing to construct the combinations of the individual sequences from a seed. Moreover, the received complete or partial priority information encoding rule may include the time and/or frequency relationships, e.g. by offsets of the individual sequences with regard to each other or offsets with regard to some reference time, for example time slot beginning, sub-frame beginning, wherein the offsets may also be zero.

Alternatively, reference sequences and/or an absolute time and/or frequency information regarding for example a specific sub-band, etc., may be comprised. Moreover, the received complete or partial priority information encoding rule may include the mapping of the priority information to the individual sequence combinations, for example sequences as such and their specific time and/or frequency relationship. In certain embodiments, only sequences are updated and/or received, wherein the number and the time and/or frequency relationships remain. Also an update only of the number and the time frequency relationships without updating the sequences is possible. Also a partial update of only a part of the sequences and/or a part of the time frequency relationships is possible.

In a twelfth implementation form of the method according to the third aspect as such or according to any of the preceding implementation forms of the third aspect, the priority information is an alarm, especially a fire alarm or a defect notification or an emergency message. A very wide priority of priority information can thereby be handled by the inventive communication device.

In a thirteenth implementation form of the method according to the third aspect as such or according to any of the preceding implementation forms of the third aspect, each of the sequences of the plurality of the orthogonal sequences is orthogonal to all time and/or frequency shifted versions of itself, every other sequence of the plurality of sequences, and all time and/or frequency shifted versions of every other sequence of the plurality of sequences. A very high degree of separation of the individual sequences can thereby be achieved.

In a fourteenth implementation form according to the method according to the thirteenth implementation form of the third aspect the sequences being orthogonal comprises the sequences having an autocorrelation peak at 0 lag above a first threshold, the sequences having a cross-correlation below a second threshold regarding all time and/or frequency shifted versions of itself, every other sequence of the plurality of sequences, and all time and/or frequency shifted versions of every other sequence of the plurality of sequences. An especially good separation of the individual sequences is thereby possible.

According a fourth aspect, a method for communicating in a communication system is provided. The method comprises receiving sequences of a plurality of orthogonal sequences, and decoding based on a priority information decoding rule, a piece of priority information encoded in a priority message, comprising a combination of at least two sequences of the plurality of orthogonal sequences. It is thereby possible to receive the priority message and decode the priority information carried by the priority message at low latency and with low hardware effort and efficient resource use.

In a first implementation form of the method according to the fourth aspect, the method comprises detecting whether the at least two received sequences from the plurality of orthogonal sequences form a priority message by determining whether the at least two sequences as such and their time and/or frequency relationship match a known combination of at least two sequences forming a priority message. A very exact determination, if a received combination of at least two sequences is constituting a priority message, or not, is thereby possible.

In a second implementation form of the method according to the fourth aspect as such or according to the first implementation form of the fourth aspect, the combination of the at least two sequences is defined by the at least two sequences and their time and/or frequency relationship to each other. Especially, the combination can be defined by the selection of the at least two sequences as such and/or their time and/or frequency relationship. A great flexibility in selecting the combination can thereby be achieved.

In a third implementation form of the method according to the fourth aspect as such or according to any of the preceding implementation forms of the fourth aspect, the priority information decoding rule defines which individual sequences of the plurality of orthogonal sequences are selected as the at least two sequences for generating the priority message and which time and/or frequency relationship the at least two selected sequences have in the generated priority message. It is thereby easily possible to decode useful information in the combination of sequences.

In a fourth implementation form of the method according to the fourth aspect as such or according to any of the preceding implementation forms of the fourth aspect, the priority information decoding rule may be a look-up table mapping each piece of priority information to a combination of at least two sequences, wherein the priority information encoding rule is configured such that different pieces of priority information are mapped to different combinations of the at least two sequences. Alternatively, a mathematic function taking the priority information as input and returning the combination of at least two sequences can be employed. A great encoding flexibility thereby can be reached.

In a fifth implementation form of the method according to the fourth aspect as such or according to any of the preceding implementation forms of the fourth aspect, the communication system may be configured to use individual sequences of the plurality of sequences for a contention or no-contention based random access procedure. This is for example implemented into the current LTE standard. A very efficient spectrum usage can thereby be achieved.

In a sixth implementation form of the method according to the fourth aspect as such or according to any of the preceding implementation forms of the fourth aspect, the method comprises detecting based on the priority information decoding rule, whether a combination of at least two received sequences of the plurality of orthogonal sequences and their time and/or frequency relationship match a combination of at least two sequences comprised in a priority message. Additionally or alternatively, the method comprises decoding based on the priority information decoding rule, the piece of priority information by determining to which combination of at least two sequences comprised in a priority message, the received at least two sequences as such and their time and/or frequency relationship match to. A very accurate and efficient decoding is thereby possible.

In a seventh implementation form of the method according to the fourth aspect as such or according to any of the preceding implementation forms of the fourth aspect, a matching of combinations of at least two sequences of the plurality of sequences to valid combinations of sequences forming priority messages is performed. An especially accurate one-step matching and decoding can thereby be performed. Alternatively, the matching and decoding are separate steps. In this case, first a matching of individual sequences within the received signal is performed. The detected matching sequences are then afterwards checked regarding valid sequence combinations forming priority messages. This allows for a lower number of required matched filters.

In an eighth implementation form of the method according to the fourth aspect as such or according to any of the preceding implementation forms of the fourth aspect, the priority information is an alarm, especially a fire alarm or a defect notification or an emergency message. A very wide priority of priority information can thereby be handled by the inventive communication device.

In a ninth implementation form of the method according to the fourth aspect as such or according to any of the preceding implementation forms of the fourth aspect, each of the sequences of the plurality of the orthogonal sequences is orthogonal to all time and/or frequency shifted versions of itself, every other sequence of the plurality of sequences, and all time and/or frequency shifted versions of every other sequence of the plurality of sequences. A very high degree of separation of the individual sequences can thereby be achieved.

In a tenth implementation form of the method according to the ninth implementation form of the fourth aspect, the sequences being orthogonal comprises the sequences having an autocorrelation peak at 0 lag above a first threshold, the sequences having a cross-correlation below a second threshold regarding all time and/or frequency shifted versions of itself, every other sequence of the plurality of sequences, and all time and/or frequency shifted versions of every other sequence of the plurality of sequences. An especially good separation of the individual sequences is thereby possible.

In a eleventh implementation form of the method according to the fourth aspect as such or according to any of the preceding implementation forms of the fourth aspect, the method comprises decoding based on the priority information decoding rule, the piece of priority information, by evaluating a channel state parameter of a transmission channel of the priority message. It is thereby possible to increase the accuracy of determining, if an actual priority message is present, or whether merely an accidental overlap of regular preambles sent by different devices has occurred.

In a twelfth implementation form of the method according to the fourth aspect as such or according to any of the preceding implementation forms of the fourth aspect, to facilitate this determination, the priority information decoding rule may additionally include a channel state parameter information.

In a thirteenth implementation form of the method according to the fourth aspect as such or according to any of the preceding implementation forms of the fourth aspect, the method comprises decoding the piece of priority information by matched filtering received sequences using individual reference sequences of the plurality of orthogonal sequences as a reference, and detecting a reference sequence of the plurality of the orthogonal sequences if a calculated power delay profile for the individual reference sequences is larger than a detection threshold. Moreover, in this case, the method comprises detecting the priority message if a time and/or frequency relationship between peaks of detected individual reference sequences, match the combination of at least two sequences of the priority message. Especially accurate and resource efficient detection is thereby possible.

In a fourteenth implementation form of the method according to the fourth aspect as such or according to any of the preceding implementation forms of the fourth aspect, a communication system is configured to use individual sequences of the plurality of sequences for a random access procedure to establish a radio communication channel. By using the individual sequences for either the priority messages or as preambles, an especially efficient resource use can be achieved.

In a fifteenth implementation form of the method according to the fourth aspect as such or according to any of the preceding implementation forms of the fourth aspect, the method further comprises updating the priority information encoding rule and priority information decoding rule or at least a part of the priority information encoding rule and the priority information decoding rule. Moreover, it comprises storing the priority information decoding rule or the at least part of the priority information decoding rule. Also, the method comprises obtaining the stored priority information decoding rule. The method furthermore comprises transmitting the priority information encoding rule or the at least part of the priority information encoding rule. It is thereby possible to update the encoding and decoding rules, taking in account the changed device functionality or as a preventive measure for dealing with orthogonal messages.

According to a fifth aspect, a computer program with a program code for performing the above-specified methods, when the computer program runs on a computer, is provided. The above specified methods refer to the methods according to the third and fourth aspect and their respective implementation forms.

Generally, it has to be noted that all arrangements, devices, elements, units and means and so forth described in the present application could be implemented by software or hardware elements or any kind of combination thereof. Furthermore, the devices may be processors or may comprise processors, wherein the functions of the elements, units and means described in the present applications may be implemented in one or more processors. All steps which are performed by the various entities described in the present application as well as the functionality described to be performed by the various entities are intended to mean that the respective entity is adapted to or configured to perform the respective steps and functionalities. Even if in the following description or specific embodiments, a specific functionality or step to be performed by a general entity is not reflected in the description of a specific detailed element of that entity which performs that specific step or functionality, it should be clear for a skilled person that these methods and functionalities can be implemented in respect of software or hardware elements, or any kind of combination thereof.

### BRIEF DESCRIPTION OF DRAWINGS

The present invention is explained in detail in relation to embodiments of the invention in reference to the enclosed drawings, in which

FIG. 1 shows a preamble-based resource allocation scheme, as for example employed by LTE;

FIG. 2 shows two communication devices according to an embodiment of the invention;

FIG. 3 shows two communication devices according to an embodiment of the invention in a block diagram;

FIG. 4 shows a time and/or frequency relationship of sequences used by different embodiments of the invention;

FIG. 5 shows a time delay between correlation peaks occurring while receiving a combination of sequences;

FIG. 6 shows an exemplary message flow diagram with messages as used by embodiments of the invention;

FIG. 7 shows a simultaneous reception of a sequence used as a conventionally preamble and a plurality of sequences used for encoding a priority message;

FIG. 8 shows correlation peaks in an exemplary time-diagram while receiving a combination of sixteen sequences and a single random access preamble;

FIG. 9 shows a method according to an embodiment of the invention in a flow diagram; and

FIG. 10 shows another method according to an embodiment of the invention in a flow diagram.

In the Figures, identical reference signs are used for identical or at least functionally equivalent features.

### DETAILED DESCRIPTION

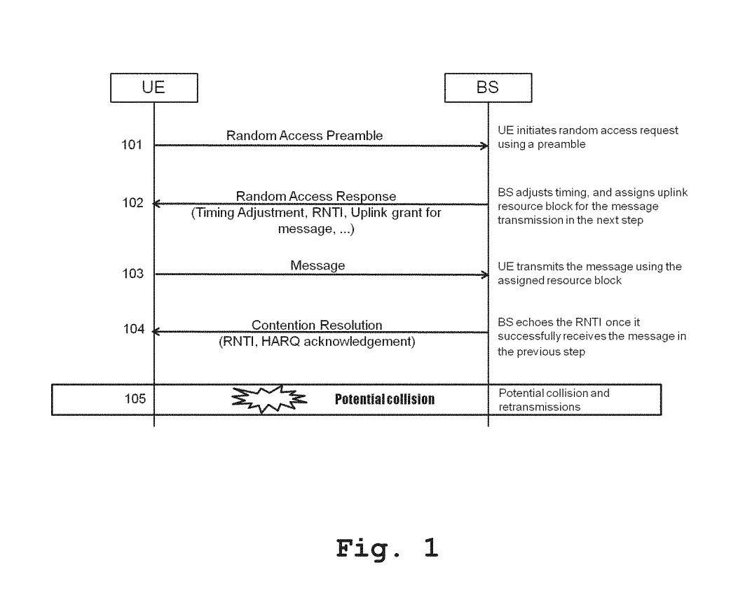

For a better understanding of the embodiments of the invention, the function of a preamble based resource allocation method is first described, as for example implemented in LTE along FIG. 1.

In an LTE system, preambles are used in the random access procedure for the collision resolution: The UE transmits a preamble in advance in order to request dedicated time-frequency resource blocks from the BS. Once the preamble is received and detected by the BS, the BS grants the uplink resource block to the UE, and the actual message transmission starts. The whole procedure comprises four steps depicted in FIG. 1:

Step 101: The UE transmits a randomly selected preamble sequence to the BS. The possible set of preamble sequences is known by the UE and the BS. Therefore, the preamble can be used as training sequence and signature as well. The BS can detect different preambles and send responses to individual preambles.

Step 102: The BS transmits a response in the downlink shared channel in response to the detected preamble sequence. For each detected preamble sequence, the BS assigns uplink resources to the corresponding terminal device or devices.

Step 103: The UE transmits its identity and other messages to the BS using the resource assigned Step 102.

Step 104: The BS echoes the terminal device identity it received in Step 103.

If multiple devices select the same preamble at the same random access time slot, the BS may not distinguish the requests from different terminal devices. Hence, the same uplink resource will be assigned to both UEs. Then, in Step 103, both UEs use the same resource for the transmission, and a collision occurs. In case the message sent in Step 103 cannot be decoded correctly, the corresponding UE will not receive the confirmation in Step 104. Then, these UEs will reinitialize the preamble transmission after certain time as in Step 105, which will delay the whole procedure for setting up a communication further.

A wireless communication system comprising at least one receiver and multiple transmitters on the uplink (UL) is used as baseline. The transmitters could be User Equipments (UEs) as in the LTE system, or wireless communication modules, which are integrated in service-specific devices, such as teleprotection equipment (TPE) or traffic safety equipment, or other terminal devices with a transmission function. The receiver could moreover be a base station (BS) as in the LTE network or other wireless networks. The receiver could also be a wireless communication module, which is directly integrated in service-specific devices, or other devices with receiving function.

In the considered problem, the transmitter needs to send an emergency message to the receiver. The transmission requests from each of the transmitters occur randomly, so that the transmissions are not scheduled in advance. Since all the transmitters share the same wireless medium regarding time and frequency resources, a collision situation where more than one transmitter ask for the same resource for transmission, cannot be avoided. The message should be received successfully at the receiver with very high reliability, regardless of collision situation and channel conditions.

The message sent by the transmitter is usually short. It could even be a single-bit signal to report the event, e.g., the occurrence of a failure. The receiver should, however, be able to identify the source of the message, that is to say, to recognize which transmitter has sent the message. Furthermore, the whole mechanism should be robust against misdetection and forgery.

The event of an emergency message, in the following also referred to as priority information is not predictable. Therefore, the radio resource cannot be scheduled in advance. A random access procedure should be launched in this case. There are two different kinds of random access procedures, namely contention-based random access and contention-free random access.

In a contention-based random access procedure (see for example FIG. 1 for LTE), any transmitter can use any available radio resource, which is reserved for the random access purpose, for its transmission. The radio resources could be time and frequency blocks as in an OFDM system or the spreading sequences in a CDMA system. If more than one transmitter select the same resource, a collision occurs. In an LTE system, as mentioned above, preambles are used in the random access procedure for the collision resolution: The UE transmits a preamble in advance in order to request dedicated time-frequency resource blocks from the BS. Once the preamble is received and detected by the BS, the BS grants the uplink resource block to the UE, and the actual message transmission starts.

The total procedure, for example in LTE, needs around 40 to 50 ms, and the procedure completion time is extended in case of the occurrence of a collision. The collision probability, namely the probability that multiple UEs transmit the same random access preamble at the same random access time slot, can be reduced if the set of available preambles is expanded.

It is proposed that one UE can select multiple, non-overlapping preambles in consecutive time frames. According to this proposal, a collision only occurs only if two or more UEs select exactly the same permutation of preambles at the same random access time slot. In this way, the number of contention resources is expanded and the amount of collisions is reduced.

In the CSMA (Carrier Sense Multiple Access) scheme, the transmitting device senses and detects the signal from other devices before the actual data transmission. This scheme implies a certain delay due to the time period, in which the devices sense whether the channel is available. Furthermore, the CSMA scheme is based on the assumption that one transmitter can detect the signal from other transmitters from a distance. This is a practical limitation, particularly in an area with a cell radius over several hundred meters. In order to be able to detect other transmitters, the transmitters have to be located close to each other. Otherwise, the CSMA scheme will suffer from the hidden node problem, which also frequently occurs in WLAN systems.

If contention-free schemes are applied, dedicated radio resources are reserved and assigned to each transmission. In particular, for use cases, in which the number of transmitters is considerably large, e.g., envisioned use cases for the next-generation wireless and mobile communication systems, a reservation of specific time and frequency resources for each transmitter is not feasible or practical. Furthermore, since the event of emergency messages is rather rare, allocating dedicated resources for such messages is inherently inefficient.

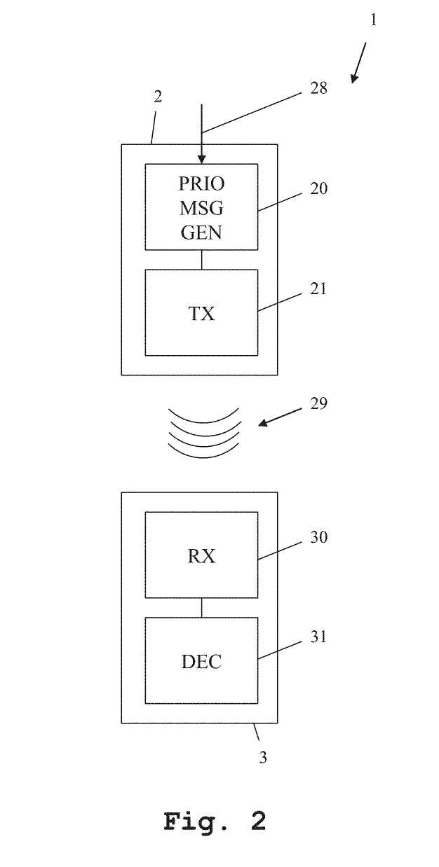

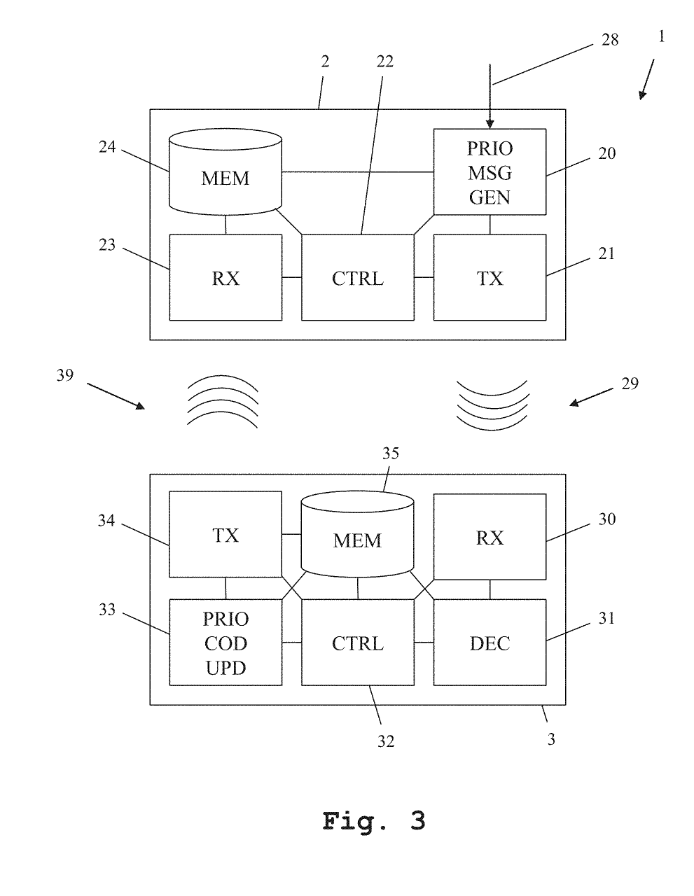

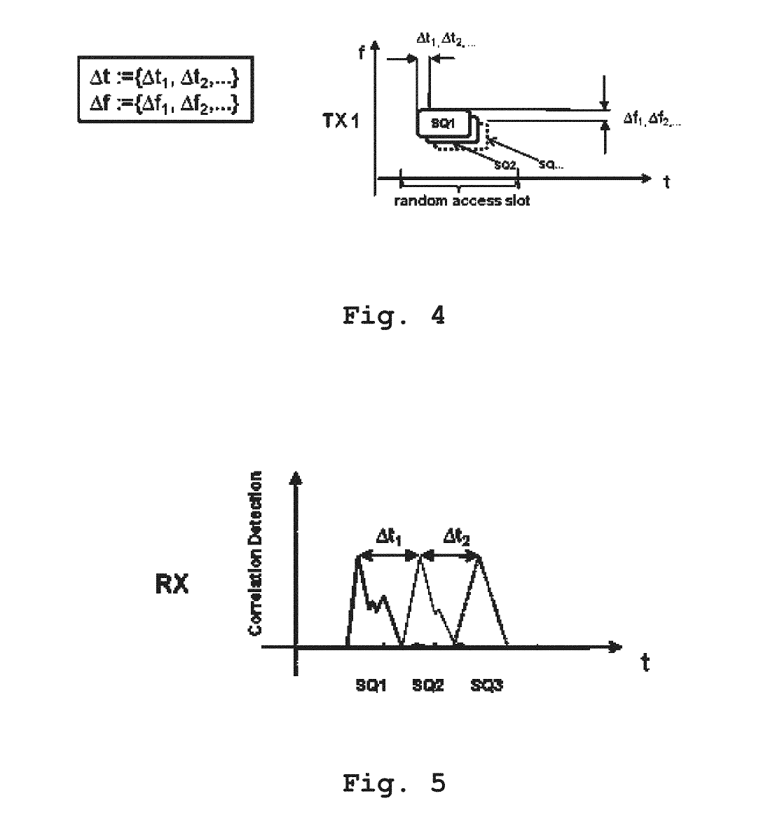

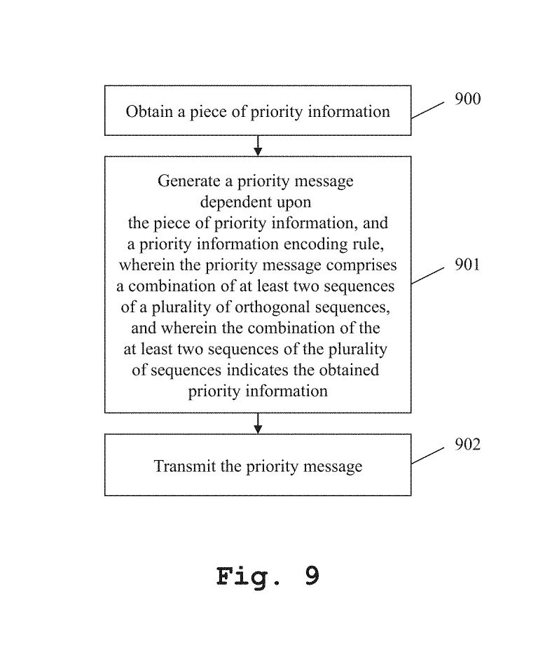

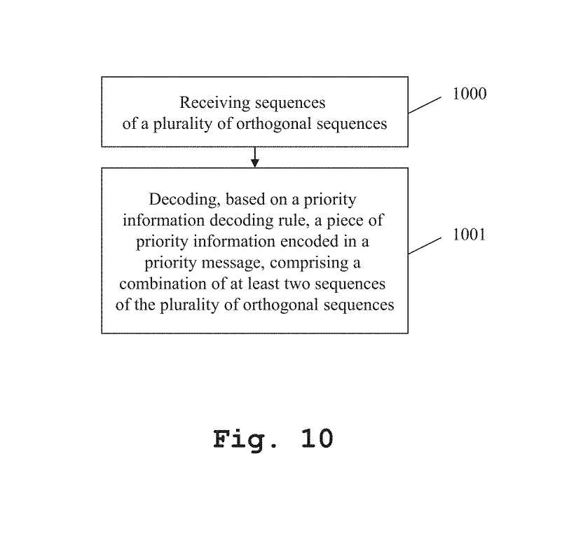

In the following, along FIG. 2 and FIG. 3, the construction and function of communication devices according to the embodiments of the invention are discussed. Along FIG. 4-FIG. 8, further details regarding the function are then given. Finally, along FIG. 9 and FIG. 10, method embodiments of the invention are described in detail.

In the following, a method and device for transmitting and receiving emergency messages, also referred to as priority messages, via a random access channel are provided. The actual message and the identification of the transmitter are immediately embedded in the combination of particular sequences. Furthermore, the receiver advantageously exploits its knowledge about a predefined time- and/or frequency shift between the individual sequences and the knowledge about the wireless channel, in order to improve the reliability and in order to avoid misdetection or forgery. If the same sequences are used as the random access preambles in the conventional random access procedure as described earlier, the same radio channel can be reused by the conventional random access and the emergency message services at the same time.

In FIG. 2, two communication devices according to an embodiment of the invention are shown. Especially, a communication device 2 for use in the communication system 1 comprising a priority message generator 20, abbreviated by “PRIO MSG GEN” in FIG. 2 connected to a transmitter 21, abbreviated by “TX” in FIG. 2 is shown.

Moreover, a communication device 3 for use in the communication system 1 is shown. The communication device 3 comprises a receiver 30, abbreviated by “RX” in FIG. 2 and connected thereto a decoder 31, abbreviated by “DEC” in FIG. 2.

The priority message generator 20 of the communication device 2 is configured to obtain a piece of priority information 28, for example a defect notice or a fire alarm and to generate a priority message 29 based on the piece of priority information 28 and a priority information encoding rule. The priority message 29 is generated by the priority message generator 20 as a combination of at least two sequences of a plurality of orthogonal sequences. The combination of sequences indicates the obtained priority information. The generated priority message 29 is then transmitted by the transmitter 21.

The receiver 30 of the communication device 3 is configured to receive sequences of a plurality of orthogonal sequences. Moreover, the decoder 31 of the communication device 3 is configured to decode, based on a priority information decoding rule, a piece of priority information 28 encoded in a priority message 29, comprising a combination of at least two sequences of the plurality of sequences. The communication device 3 can therefore receive and decode the priority information, which was encoded and transmitted by the communication device 2.

In FIG. 3, two communication devices according to another embodiment of the invention are shown. Here, the communication devices 2, 3 comprise further entities for performing further functions.

Especially, the communication device 2 additionally comprises a control unit 22, abbreviated by “CTRL” in FIG. 3, a receiver 23, abbreviated by “RX” in FIG. 3, and a memory 24, abbreviated by “MEM” in FIG. 3. Each of the units 20, 21, 23 and 24 are connected to the control unit 22 and are controlled thereby. Especially, the control unit 22 serves the purpose of facilitating communication between the other units and generating instructions for the other units. Moreover, the storage 24 is connected to the receiver 23 and to the priority message generator 20.

The receiver 23 is configured to receive the priority encoding rule 39 or at least a part of the priority encoding rule 39. The receiver 23 then hands this priority encoding rule 39 or the part thereof to the memory 24, which is configured for storing the priority information encoding rule 39 or the part thereof. The priority message generator 20 is moreover configured to obtain the priority information encoding rule 39 from the memory 24.

Moreover, the communication device 3 here additionally comprises a control unit 32, abbreviated by “CTRL” in FIG. 3, a priority information coding updater 33, abbreviated by “PRIO COD UPD” in FIG. 3, a transmitter 34, abbreviated by “TX” in FIG. 3 and a memory 35, abbreviated by “MEM” in FIG. 3. Also, the decoder 31 is connected to the memory 35.

Moreover, the transmitter 34 is additionally connected to the priority information encoding updater 33 and to the memory 35. The memory 35 and the priority information coding updater 33 are moreover connected to each other. Each of the units 30, 31, 33, 34 and 35 is connected to the control unit 32 and controlled thereby. Especially, the control unit 32 serves the purpose of facilitating communication between the other units and generating instructions for the other units.

The priority information coding updater 33 is configured to update the priority information encoding rule 39 and priority information decoding rule or at least a part of priority information encoding rule 39 and priority information decoding rule. The updated encoding and decoding rules are stored by the memory 35. The decoder 31 is moreover configured to obtain the priority information decoding rule from the memory 35 and decode the received sequences using this priority information decoding rule.

The transmitter 34 is further configured to transmit the priority information encoding rule 39 or the at least a part of the priority information encoding rule 39. Especially, it is configured to transmit the priority information encoding rule 39 to the receiver 23 of the communication device 2. It is thereby possible to update the encoding and decoding rules by the communication device 3 and instruct the communication device 2 of the updated rules.

In the following, more details regarding the possible implementations are given:

Unlike the random access procedure used in current UMTS and LTE systems, the proposed random access procedure does not apply a separate preamble transmission and message transmission. The transmitter sends the message immediately without the transmission of preambles.

The message is carried by a combination of particular sequences. These sequences are designed in such way that they are orthogonal. This means that they have very low cross-correlation with each other. Furthermore, they have a low correlation with themselves at different time and/or frequency offsets. One example are Zadoff-Chu sequences which have the advantageous properties regarding autocorrelation and cross-correlation.

The periodic autocorrelation is defined as

ρ_{ff}(τ)=Σₜ₌₀^{T-1}f(t)f̅(t+τ),

where f(t) is a periodic extension of the sequence with the property f(t)=f(t+nT), nϵZ. T is the length of the sequence, Z is the set of the integers and f̅ represents the complex conjugate.

The periodic cross-correlation of two sequences is defined as

ρ_{fg}(τ)=Σₜ₌₀^{T-1}f(t)g̅(t+τ).

The periodic autocorrelation of the applied sequence has a single peak at zero time lag τ=0 and very low value at non-zero time lag τ≠0. In the case of Zadoff-Chu sequences, the periodic autocorrelation is a Dirac delta function, and it is exactly zero at non-zero lag. The absolute value of the periodic cross-correlation function between two different sequences out of the plurality of sequences is very low. If the value of the periodic cross-correlation between two sequences out of the plurality of sequences is lower than certain threshold, e.g. 3 dB lower than the peak of the periodic autocorrelation of each sequences, it is said that these two sequences out of the plurality of sequences are orthogonal.

The strictness of the orthogonality, i.e. the setting of the threshold value will impact the ease of detection at the receiver. The lower the threshold, the easier the sequence can be detected among other sequences. Further examples are the Pseudo Noise (PN) sequences such as Gold codes, Kasami codes, Walsh-Hadamard codes, and Barker codes.

Based on the correlation properties, the receiving communication device 3 can distinguish each sequence out of the plurality of sequences individually among other sequences out of the plurality of sequences which are received at the same time. The sequences can be identified at the receiving communication device 3, for example by performing matched filtering. The power delay profile of a particular sequence is computed by matched filtering with an original reference sequence. If the peak of the power delay profile is above a detection threshold, then it is supposed that the particular sequence has been used by the transmitter. Setting a target probability of misdetections, i.e. the maximum probability of misdetections that can be tolerated in the sequence detection procedure, the detection threshold can be pre-computed. Alternatively, the detection threshold can also be adjusted empirically.

In addition, the sequences do not necessarily have to be time and/or frequency synchronized with each other. That is to say, different transmitting communication devices may multiplex their transmissions on the same frequency and time resource without any form of time and/or frequency synchronization.

If the transmitting communication device 2 is to send a priority message, it transmits a combination of aforementioned sequences out of the plurality of sequences in one random access slot, inserted with a specified and/or determined time and/or frequency shift Δt/Δf. The shift between the sequences can be individually defined for each sequence, as shown in FIG. 4.

In FIG. 4, the time shift and frequency shift between sequence 1 (SQ1) and sequence 2 (SQ2) are denoted by Δt₁ and Δf₁, respectively. Δt₂ and Δf₂ denote, respectively, the time shift and frequency shift between SQ2 and SQ3, and so on. The shifts Δt₁ and Δt₂, etc. can be individually defined, as well as the Δf₁ and Δf₂, etc.

Then, the combination of the sequences out of the plurality of sequences characterized by Δt and Δf is received and detected by the receiving communication device 3. The corresponding transmitting communication device 2 and its piece of priority information can be uniquely identified if the specification of the sequences and the shifts Δt and Δf, which are also referred to as priority information encoding rules, are known at the receiver.

FIG. 5 shows an example of the detection by the receiving communication device 3 (RX). The receiving communication device 3 detects three sequences SQ1, SQ2, SQ3 with specified time shifts Δt₁ and Δt₂ If this combination including the shifts is uniquely assigned to a transmitting communication device 2 (TX1) for a particular message in advance, the receiving communication device 3 can identify the corresponding transmitting communication device 2 and the reported message. The same mechanism works also for the frequency shift Δf.

Some sequences, such as the Zadoff-Chu sequences or Pseudo Noise (PN) sequences, have the aforementioned correlation properties in both time and frequency domains, so the receiving communication device 3 is able to accurately estimate the time and frequency shifts Δt and Δf in the same random access slot. In this case, both the time and frequency shifts Δt and Δf can be used to characterize the combination of the sequences. For some sequences, only the time shift Δt or the frequency shift Δf can be well estimated at the receiver, so only this particular shift can be used to characterize the combination of sequences.

FIG. 6 illustrates the complete procedure to transmit priority messages.

In a normal operation mode, namely no priority event leading to the necessity of transmitting a priority message occurring, in Step 601 a particular sequence combination including the specification of Δt/Δf is assigned to each transmitting communication device for a particular message in advance.

Furthermore, since the channel state between the transmitting communication device 2 and the receiving communication device 3 can be stable, which is the common case for stationary transmitters such as metering devices, the channel state information, particularly a MIMO channel, can be utilized for the identification of the transmitters. The stability of the channel can be determined based on the fluctuations of the power envelope of the received signal. The power envelope may comprise long-term fading effects or short-term fading effects or both. To determine the amount of fluctuations of the power envelop of the received power in terms of the thresholds, e.g., lower and upper limits of the power envelope can be used. The stability information may also comprise the mobility state of the receiving communication devices, which may also be quantized, e.g., low, middle, or high speed. The mobility state may be relative to ground or to the target receiving communication device 3. The report of the channel state information, which is denoted as Step 602 in FIG. 6, is an optional step in the procedure. However, it is a default step in periodic metering reports, for example in smart grids.

In order to increase the security and prevent the forgery of the messages, the sequence combination and specification of Δt/Δf can be updated after a certain determined period. The determined period can be updated, e.g., based on security use case requirements.

In an emergency report mode, namely an emergency message, also referred to as priority information occurs, the message is send to the receiving communication device 3 immediately by transmission of the pre-assigned sequence combination. This action is denoted as Step 603 in FIG. 6. For instance, if 64 different Zadoff-Chu sequences are available, the factorial of 64, i.e., 64!, which is approximately 10⁸⁹, different combinations or messages can be generated. The number of these combinations may be increased by repeating the same sequence, e.g., when either the time or frequency shift is inserted.

The specification of the sequence combination and Δt/Δf can be organized and assigned by the receiver to the transmitter as shown in FIG. 6. Optionally, the specification of the sequence combination and Δt/Δf can be organized by another central entity, e.g., a central base station, and be distributed to the corresponding communication devices 2, 3.

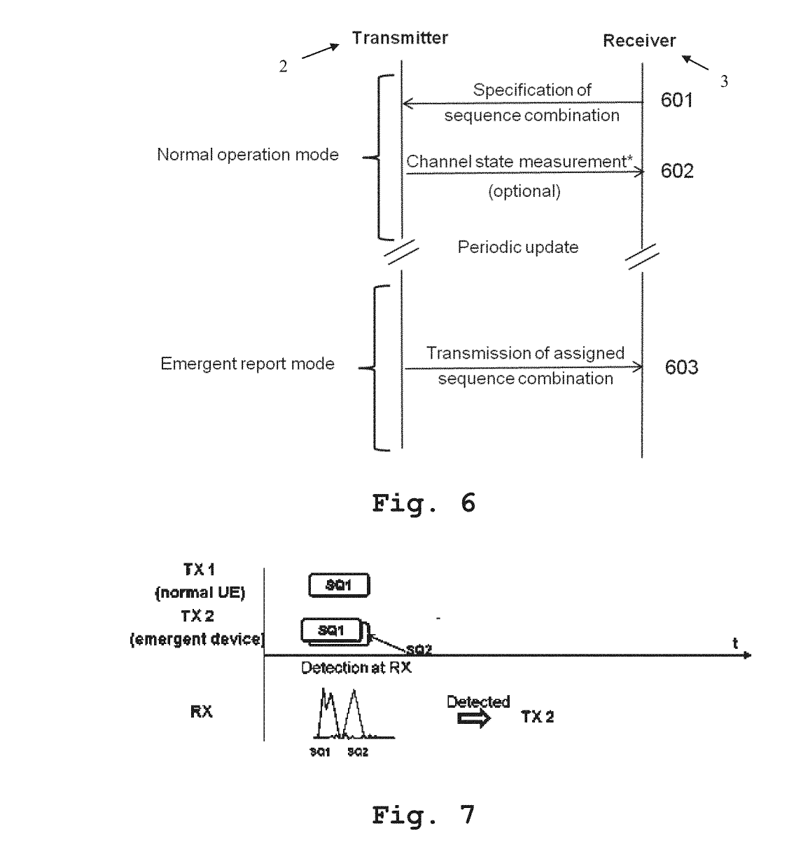

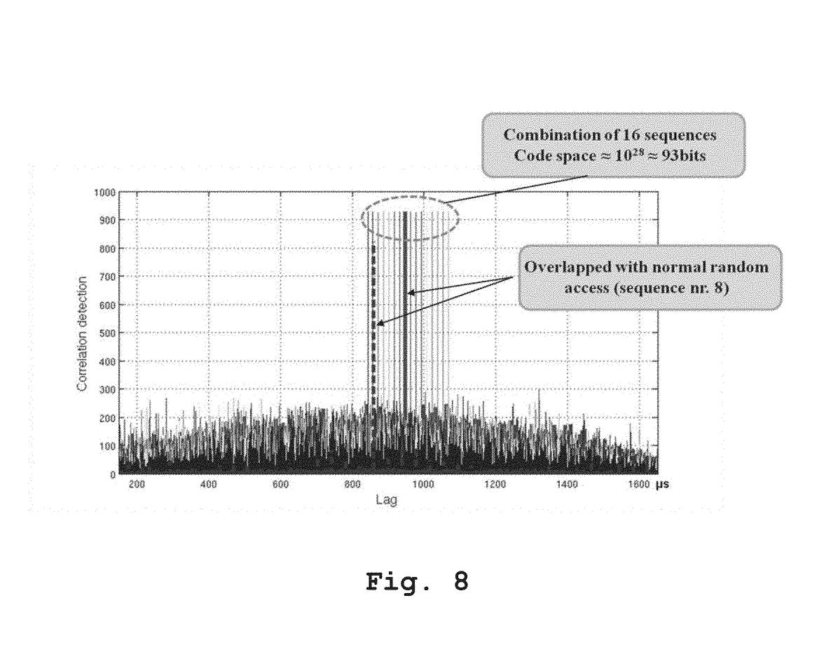

The proposed emergency random access scheme can be integrated into current cellular networks, e.g., LTE, by reusing the existing random access channel. In an example shown in FIG. 7, if the LTE network uses the same set of sequences as the preambles in the random access channel, a normal UE (TX1) will use for example a sequence 1 (SQ1) as the preamble to initialize a normal random access procedure as described regarding FIG. 1. If at the same time, the device TX2, which is a transmitting communication device 2 according to the invention, wants to send a priority information, it exemplarily sends a combination of SQ1 and SQ2 in the same radio channel as a priority message. The receiving communication device 3 RX detects the SQ1 and SQ2. If the combination and the time and/or frequency shift meets the specification for TX2, the message of TX2 will be recognized. At the same time, the random access request from TX1 may be blocked, and TX1 performs the normal random retransmission procedure, as described earlier.

In another embodiment, the apparatus 3 is configured to distinguish the two SQ1 sequences (e.g. because they are shifted by time or frequency from each other), and thus decodes the combination of sequences SQ1 and SQ2 originated from TX2 as priority message, and at the same time detects the sequence SQ1 originated from TX1 as normal or conventional random access message and establishes a communication channel for TX1.

In some embodiments, apparatus 3 may be configured to, when having decoded or detected a priority message 29, additionally establish a communication channel for the apparatus 2, e.g. a User equipment (UE) and/or TPE, e.g. for exchanging further information related to the priority or emergency case or for sending control information to the apparatus 2. In yet some embodiments, apparatus 3 may be configured to process the decoded priority information (e.g. as TPS). In still some embodiments, apparatus 3 may be configured to forward the priority information received from the apparatus 2 to some other device or network entity, e.g. a TPS, e.g. also without establishing a communication channel to apparatus 2.

The TPS or the functionality of the TPS may be integrated into the apparatus 3, e.g. another terminal or a base station, or may be implemented in another network element or device.

Specific combinations of sequences comprised in or forming priority messages 29 may be uniquely assigned to apparatus 2 to avoid collisions of identical combinations sent from different apparatus 2, e.g. TPE. Furthermore, each apparatus 2 may be assigned one or a plurality of unique combinations of at least two sequences. In a typical case it is expected that 3 to 4 different combinations of sequences are assigned to one apparatus 2, e.g. each indicating a different priority information, e.g. a specific emergency or fault information.

FIG. 8 shows an example of a priority message being sent using a combination of 16 sequences. In the same random access time slot, the sequence 8 (SQ8) is sent by a regular UE as a preamble. The combination of sequences detected by receiving communication device 3 is marked as solid line in the figure and the normal random access preamble is marked as dashed line. It can readily be seen that the sequences share the same resource slot.

In FIG. 9, a method according to an embodiment of the invention is shown in a flow diagram. In a first step 900, a piece of priority information is obtained. In a second step 901, a priority message is generated based thereupon. Especially, the priority message is generated dependent upon the piece of priority information and a priority information encoding rule. The priority message comprises a combination of at least two sequences of a plurality of orthogonal sequences. The combination of the at least two sequences of the plurality of sequences indicates the obtained priority information. In a third step 902 the generated priority message is transmitted.

In FIG. 10, another method according to an embodiment of the invention is shown. In a first step 1000, sequences of a plurality of orthogonal sequences are received. In a second step 1001, based on a priority information decoding rule, a piece of priority information encoded in a priority message, comprising a combination of at least two sequences of orthogonal sequences, is decoded.

The invention is not limited to the above embodiments and especially not the communication standard LTE. The invention discussed above can be applied to many communication standards. Also, there is no limitation on only a single transmitting communication device and only single receiving communication device. The characteristics of the exemplary embodiments can be used in any advantageous combination.

The invention has been described in conjunction with various embodiments herein. However, other variations to the disclosed embodiments can be understood and effected by those skilled in the art in practicing the claimed invention, from a study of the drawings, the disclosure and the appended claims. In the claims, the word “comprising” does not exclude other elements or steps and the indefinite article “a” or “an” does not exclude a plurality. A single processor or other unit may fulfill the functions of several items recited in the claims. The mere fact that certain measures are recited in usually different dependent claims does not indicate that a combination of these measures cannot be used to advantage.

A computer program may be stored and/or distributed on a suitable medium, such as an optical storage medium or a solid-state medium supplied together with or as part of other hardware, but may also be distributed in other forms, such as via the internet or other wired or wireless communication systems.

1. A communication device for use in a communication system, wherein the communication device comprises:
a priority message generator configured to obtain a piece of priority information, and to generate a priority message based on the piece of priority information and a priority information encoding rule, wherein the priority message comprises a combination of at least two sequences of a plurality of orthogonal sequences, and wherein the combination of the at least two sequences of the plurality of sequences indicates the obtained priority information; and
a transmitter configured to transmit the priority message.

2. The communication device of claim 1,
wherein the at least two sequences are at least two different sequences of the plurality of orthogonal sequences;
wherein the at least two sequences comprised in the priority message have a time and/or frequency shift regarding each other; and/or
wherein the at least two sequences comprised in the priority message overlap in time and/or frequency regarding each other.

3. The communication device of claim 1,
wherein the plurality of sequences are a plurality of Zadoff-Chu sequences, Pseudo Noise (PN) sequences, Gold Code sequences, Kasami Code sequences, Walsh-Hadamard code sequences or Barker Code sequences.

4. The communication device of claim 1,
wherein the communication system is configured to use individual sequences of the plurality of orthogonal sequences for a random access procedure to establish a radio communication channel.

5. The communication device of claim 1,
wherein the communication device is a long term evolution, LTE, communication device,
wherein the plurality of orthogonal sequences are Zadoff-Chu sequences of a same set used for random access preambles, and
wherein the random access preambles and the priority messages are sent in a common RACH channel.

6. The communication device of claim 1, wherein the communication device further comprises:
a receiver configured to receive the priority information encoding rule or at least a part of the priority information encoding rule; and
a memory storage configured to store the priority information encoding rule or the at least a part of the priority information encoding rule; and
wherein the priority message generator is configured to obtain the priority information encoding rule from the memory.

7. A communication device for use in a communication system, wherein the communication device comprises:
a receiver configured to receive sequences of a plurality of orthogonal sequences; and
a decoder configured to decode, based on a priority information decoding rule, a piece of priority information encoded in a priority message, comprising a combination of at least two sequences of the plurality of orthogonal sequences.

8. The communication device according to claim 7,
wherein the decoder is configured to detect based on the priority information decoding rule whether a combination of at least two received sequences of the plurality of orthogonal sequences and their time and/or frequency relationship match a combination of at least two sequences comprised in a priority message; and/or
wherein the decoder is configured to decode based on the priority information decoding rule, the piece of priority information by determining to which combination of at least two sequences comprised in a priority message, the received at least two sequences as such and their time and/or frequency relationship match to.

9. The communication device according to claim 7,
wherein the decoder is configured to decode based on the priority information decoding rule, the piece of priority information, by evaluating a channel state parameter of a transmission channel of the priority message.

10. The communication device according to claim 7,
wherein the decoder is configured to decode the piece of priority information by matched filtering the received sequences using individual reference sequences of the plurality of orthogonal sequences as reference, and detecting a reference sequence of the plurality of the orthogonal sequences if a calculated power delay profile for the individual reference sequence is larger than a detection threshold;
and detecting the priority message, if a time and/or frequency relationship between peaks of detected individual reference sequences match the combination of at least two sequences of the priority message.

11. The communication device according to claim 7,
wherein the communication system is configured to use individual sequences of the plurality of sequences for a random access procedure to establish a radio communication channel.

12. The communication device of claim 7, wherein the communication device further comprises:
a priority information coding updater configured to update the priority information encoding rule and priority information decoding rule, or at least a part of the priority information encoding rule and priority information decoding rule; and
a memory storage configured to store the priority information decoding rule or the at least part of the priority information decoding rule; and
a transmitter configured to transmit the priority information encoding rule or the at least a part of the priority information encoding rule; and, wherein
the decoder is configured to obtain the priority information decoding rule from the memory; and

13. A method for communicating in a communication system, wherein the method comprises:
obtaining a piece of priority information; and
generating a priority message based on the piece of priority information and a priority information encoding rule, wherein the priority message comprises a combination of at least two sequences of a plurality of orthogonal sequences, and wherein the combination of the at least two sequences of the plurality of sequences indicates the obtained priority information; and
transmitting the priority message.
